(19) United States
(12) Patent Application Publication
(10) Pub. No.: US 2002/0182560 A1
(43) Pub. Date: Dec. 5, 2002

(54) Implant for teeth orthodontics

(76) Inventors: Young-Chel Park, Seoul (KR); Jong-Suck Lee, Seoul (KR)

Correspondence Address: William H Logsdon, 700 Koppers Building, 436 Seventh Avenue, Pittsburgh, PA, 15219-1818, US

(21) Appl. No.: 10/070,961

(22) PCT Filed: Jul. 5, 2001
(86) PCT No.: PCT/KR01/01154

(30) Foreign Application Priority Data
Jul. 12, 2000 (KR) 2000/19997

(51) Int. Cl. A61C 3/00; A61C 8/00

(52) U.S. Cl. 433/18; 433/173; 433/174

(57) ABSTRACT

An implant for teeth orthodontics to fix firmly the orthodontic appliance ligated to malaligned teeth, to decide freely the pulling direction of a bracket mounted on malaligned teeth, and to minimize the size of the exposed part of an implant after implanting into dentine of teeth. The present invention is composed of a screw part at its bottom side to be implanted into dentine of teeth, a plain part at its middle side to be contacted with gingival tissue, and a head part at its upper side having a groove for manipulation of the implant by tools, a wire slot for a wire to be inserted therein, and a ligation part for a wire to be ligated.

### TECHNICAL FIELD

The present invention relates generally to an implant for teeth orthodontics, and more particularly to an implant for teeth orthodontics which securely and firmly fixes an orthodontic appliance fitted onto the dentition so as to straighten mal-aligned teeth (such as a snag tooth, an in-turned tooth, a projecting tooth, a cracked tooth) and/or which precisely and correctly straightens the malaligned teeth by implanting directly into an alveolar bone or a basal bone (hereinafter, referred to as “the dentine of teeth”) having mal-aligned teeth.

### BACKGROUND ART

Continuous research and development to provide implants for prosthetic appliances so as to replace missing teeth have been carried out, and thus numerous types of the implants for the prosthetic appliance have previously been proposed. However, the research and development of implants for fixing orthodontic appliances to straighten mal-aligned teeth (hereinafter, referred to as “the teeth”) or for straightening the mal-aligned teeth are not sufficient.

Until now the implant for the prosthetic appliance has been used to fix the orthodontic appliance. However, this kind implant has a problem that a bracket installed at a position may be detached from that position, because the implant doesn't have a portion to which a wire is fixedly attached, and thus the implant is separately equipped with a bracket on the upper portion of the implant.

Recently, Korean Utility Model Appln. No. 1999-30323 discloses an implant to overcome said problems. In this application, the implant includes on the upper position of the implant a hanging plug 12 with a hanging piece 11 on the top of the implant as shown in FIG. 1. A head portion 13 to which a dental tool is connected is formed under the hanging plug 12. An annular projecting portion 15 is formed under the head portion 13 while having a clearance 14 to hang an elastomer 23. A screw portion 16 is formed under the projecting portion 15 to be implanted into the dentine of teeth.

In order to implant the implant 10 constructed in this way into the dentine of teeth, a dentist connects a dental tool to the head portion 13 and implants the screw portion 16 into the dentine of teeth through soft tissue 6f the gingiva 22 by rotating the dental tool, and then ligates a wire and an elastomer 23, which are ligated to the bracket 20 fixedly attached to the teeth so as to treat the teeth 21, to the clearance 14 or the hanging plug 12.

However, the exposed range is wide because all of the projecting portion 15, the clearance 14, the head portion 13, the hanging plug 12 and the hanging piece 11 of said implant 10 are exposed to the exterior of the gingiva 22 after the screw portion 16 is implanted into the dentine of teeth. Thus the conventional implant has a problem that it may give an unpleasant feeling because food is caught in the lip side or tongue side when they eat depending on the position of the implant 10. It also has a problem that food dregs remain in the teeth

In addition to the said problems, the conventional implant has a problem that it is not able to straighten the teeth 22 precisely, because the wire W of the implant ligated to the bracket 20 fixedly attached to the teeth 22 so as to treat the teeth 22 can be pulled in only one direction. Also the hanging plug 12 and the clearance 14 to which the wire and elastomer 23 are ligated may be broken. The implant may also cause inflammation of the soft tissue or the gingiva, into which the implant 10 is implanted.

### DISCLOSURE OF THE INVENTION

Accordingly, the present invention has been made keeping in mind the above problems occurring in the prior art, and an object of the present invention is to provide an implant for teeth orthodontics which fixes securely and firmly an orthodontic appliance fitted onto the dentition, thereby straightening the malaligned teeth correctly and precisely.

Another object of the present invention is to provide the implant for teeth orthodontics, which freely sets a pulling direction of a bracket mounted to the malaligned teeth so as to straighten them, which reduces an unpleasant feeling when a wearer eats because the exposed range of a screw portion implanted into the dentine of teeth is minimized, and which is compatible with the surrounding gingival tissue.

### BRIEF DESCRIPTION OF THE DRAWINGS

FIG. 1 is a perspective view showing an implant for teeth orthodontics according to the prior art;

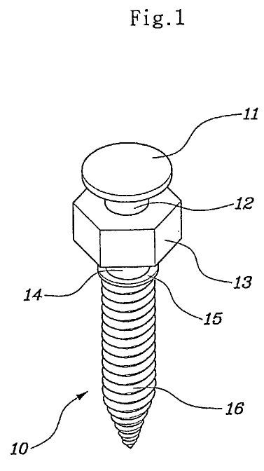

FIG. 2 is a view showing use of the conventional implant for teeth orthodontics for straightening mal-aligned teeth;

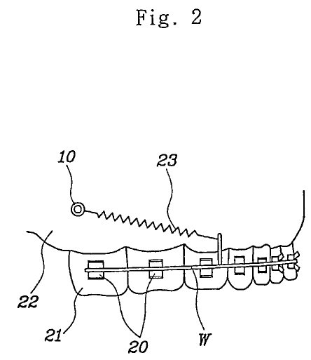

FIG. 3 is a perspective view showing an implant for teeth orthodontics according to the present invention;

FIG. 4 is a side view of the implant for teeth orthodontics of the present invention shown in FIG. 3;

FIG. 5 is a perspective view showing an implant for teeth orthodontics according to another preferred embodiment of the present invention;

FIG. 6 is a side view of the implant for teeth orthodontics shown in FIG. 5; and

FIGS. 7a and 7b are schematic views showing use of the implant for teeth orthodontics of the present invention.

### BEST MODE FOR CARRYING OUT THE INVENTION

The characteristic construction of an implant for teeth orthodontics in accordance with the present invention is described as follows.

The implant 30 of the present invention mainly comprises a screw portion 31 which is implanted into the dentine of teeth, a flat portion 32 which is implanted into the soft tissue of the gingiva, and a head portion 33 which is exposed to the exterior of the gingiva and to which a wire is ligated.

The implant for teeth orthodontics of the present invention constructed in such a way will be now described in detail with reference to accompanying drawings.

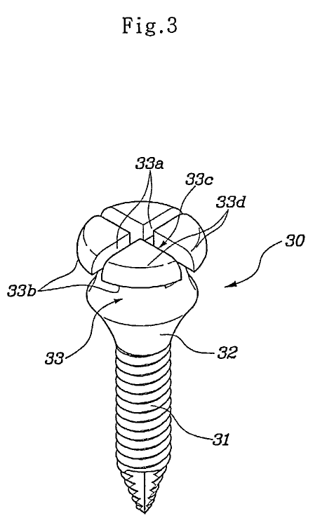

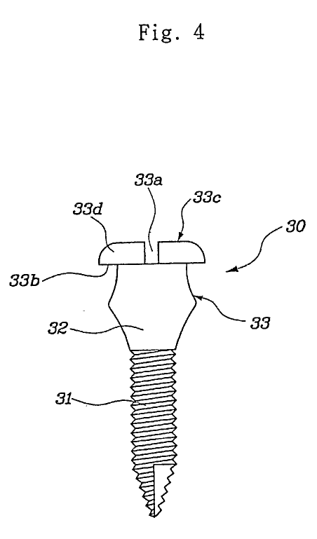

FIGS. 3 and 4 illustrate the implant for teeth orthodontics according to a first embodiment of the present invention. The tapering screw portion 31 which is implanted into the dentine of teeth through the soft tissue of the gingiva 22 is formed on the lower portion of the implant. The flat portion 32 which is implanted into the soft tissue of the gingiva is formed over the screw portion 31. The head portion 33 is formed over the flat portion 32, wherein the head portion is provided with a wire slot 33a in which a main wire 41 is received, with a wire ligating portion 33b to which a wire 42 is ligated and with a manipulating portion 33c into which a dental tool is inserted.

A manipulating portion 33c is a manipulating groove formed on the upper surface of the flat portion 32 between brackets 33d. The brackets 33d are formed oppositely at a predetermined interval. The manipulating groove is used to be inserted with a dental tool (such as a straight screwdriver and a cross screwdriver) and to implant the implant 30 into the dentine of teeth.

The wire slot 33a of a straight line shape is formed on the upper surface of the head portion 33 to have a predetermined depth. The main wire W which is connected to the bracket 20 fixedly attached to the teeth 21 is received into the wire slot 33a securely and firmly.

The wire ligating portion 33b is the portion to which the ligating wire W′ fixing the main wire W fitted into the wire slot 33a is ligated. The wire ligating portion 33b is provided with an stepped portion on the upper surface of the wire ligating portion and with an inclined surface downwardly widening along the lower surface of the wire ligating portion so as not to be displaced from the position in which the ligating wire W′ is ligated, thereby holding firmly the ligating wire W′.

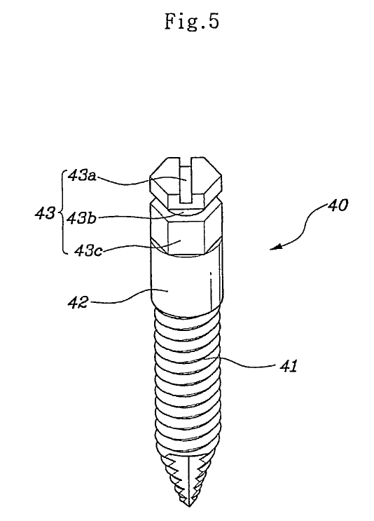

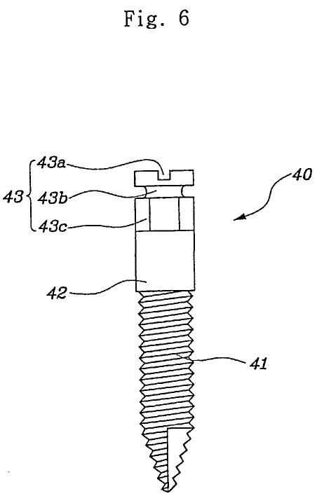

FIGS. 5 and 6 illustrate an implant for teeth orthodontics according to another embodiment of the present invention. A hexagonal nut shaped manipulating portion 43c is formed over a flat portion 42 incorporated with a screw portion 41. A wire ligating groove 43b is formed over the manipulating portion 43c along a circumferential surface to a predetermined depth so as to ligate the ligating wire W′, thereby holding firmly the ligating wire 42, similarly to FIGS. 3 and 4.

The wire slot 43a into which the main wire W is fitted is formed over the wire ligating groove 43b, thereby holding securely and firmly the main wire connected to the bracket 20 fixedly attached to the teeth 22.

The operation of the invention constructed in this way is described as follows.

The implant 30 of the invention is not complicated to manipulate, is very easy and safe to use, and is inexpensive to manufacture. Because the screw portion 31 is integrated with the flat portion 32 and the head portion 33 serving as the bracket, the implant is compatible with the gingival tissue so that it doesn't cause an inflammation of the gingiva.

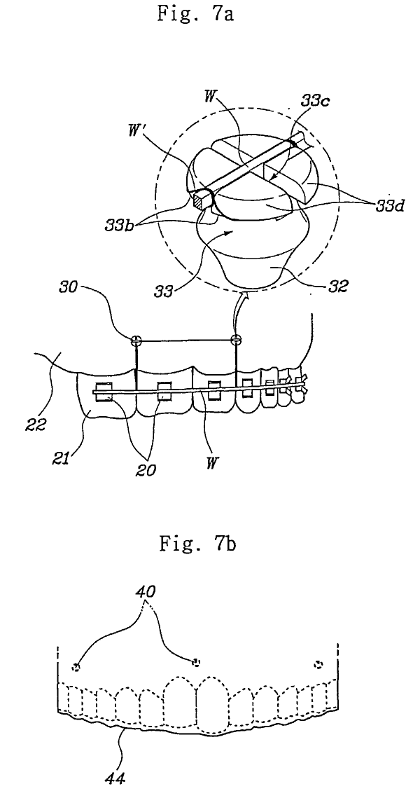

According to the invention having the characteristics as described above, when a dentist connects the dental tool to the manipulating portion 33c and implants the implant into the portion of the gingiva 22 desired, the screw portion 31 is implanted into the dentine of teeth and the flat portion 32 is implanted into the soft tissue of the gingiva 22 as shown in FIG. 7a, so that one end of the main wire W connected to the bracket 20 which is fixedly attached to one side of the teeth 21 is fitted into the wire slot 33a.

In this case, the ligating wire W′ is used to ligate securely and firmly the main wire W received in the wire slot 33a by means of the wire ligating portion 33b. The wire ligating portion 33b to which the ligating wire W′ is ligated is downward inclined from the stepped portion. Thus the invention doesn't cause the harmful effects of the gingiva 22, though ligating force of the ligating wire W′ is removed so that the ligating wire runs down and comes into contact with the gingiva 22.

Safety is guaranteed, for the wire ligating portion 43b according to another embodiment of the present invention is formed as a groove along the circumferential surface of the head portion 43 so that the ligation wire W′ is ligated to the groove.

One more implants for teeth orthodontics of the present invention are mounted to the tongue side or the lip side of the gingiva 22, and they not only push or pull the main wire W toward a side or both sides but also provide the main wire with turning force, thereby straightening precisely and correctly various types of mal-aligned teeth.

The present invention provides the implant for teeth orthodontics, which fixes securely and firmly the ortodontic appliance 44 by keeping close contact between the inside of the orthodontic appliance 44 fitted onto the dentition and the head portion which is exposed after being implanted into the gingiva 22 and the dentine of teeth, thereby straightening mal-aligned teeth correctly.

### Industrial Applicability

As described above, the present invention provides an implant for teeth orthodontics, which fixes securely and firmly an orthodontic appliance by keeping close contact between the inside of the orthodontic appliance and a head portion which is exposed after being implanted into the gingiva and the dentine of teeth so as to fix the orthodontic appliance fitted onto the dentition, thereby straightening mal-aligned teeth correctly.

The invention is directed to the implant for teeth orthodontics, which is able to pull and push the mal-aligned teeth toward one side or both sides and to be applied with turning force by integrating a screw portion with a flat portion and a manipulating portion, and which is compatible with the gingival tissue and thus doesn't cause an inflammation of the gingiva when implanted into the thin gingival tissue, thereby straightening the mal-aligned teeth easily.

The invention provides the implant for teeth orthodontics, which integrates the screw portion to be implanted into the dentine of teeth with the flat portion to be implanted into the soft tissue of the gingiva and the head portion having the wire slot serving as the bracket, wire ligating groove and the manipulating portion, thereby overcoming problems due to the bracket provided separately on the upper portion of the implant in accordance with prior art, and thereby facilitating the straightening of the mal-aligned teeth.

1. An implant for teeth orthodontics, comprising:
a screw portion which is implanted into the dentine of teeth and is formed on an lower portion of the implant;
a flat portion which is implanted into a gingiva and is formed in the middle of the implant;
a head portion which is formed on an upper portion of the implant, said head portion being provided with a manipulating portion to which a dental tool can be detachably connected, with a wire slot into which a main wire is fitted and with a wire ligating portion to which a ligating wire is ligated.

2. The implant for teeth orthodontics according to claim 1, wherein said head portion is provided with two brackets which are formed oppositely on an upper surface of the flat portion, said brackets being provided therebetween with a manipulating groove into which a dental tool is inserted.

3. The implant for teeth orthodontics according to claim 1, wherein said wire ligating portion is provided with an stepped portion on an upper portion of the wire ligating portion and with a downward inclined surface on an lower portion of the wire ligating portion so as not to be displaced from the position in which a wire is ligated.

4. The implant for teeth orthodontics according to claim 1, wherein said wire ligating portion is provided with a groove formed to a predetermined depth along a lower circumferential surface of the wire slot so as not to be displaced from the position in which the wire is ligated.

5. The implant for teeth orthodontics according to claim 1, wherein said manipulating portion is formed between an upper portion of the flat portion and the wire ligating portion to have a hexagonal nut shape.
